(19) United States
(12) Patent Application Publication
(10) Pub. No.: US 2020/0179966 A1
(43) Pub. Date: Jun. 11, 2020

(54) ATOMIZING NOZZLE

(71) Applicants: UNIVERSIDAD DE ALCALÁ DE HERNARES, Alcalá de Henares - Madrid (ES); CENTRO DE INVESTIGACIONES ENERGÉTICAS, MEDIOAMBIENTALES Y TECNOLÓGICAS(CIEMAT), Madrid (ES); THE UNIVERSITY OF STRATHCLYDE, Glasgow (ES); BPE E.K., Eckental (DE)

(72) Inventors: José Luis PÉREZ DÍAZ, Alcalá de Henares - Madrid (ES); Javier QUIÑONES DÍEZ, Madrid (ES); Yi QIN, Glasgow (GB); Yankang TIAN, Glasgow (GB); Wolfgang HORNIG, Eckentl (DE)

(21) Appl. No.: 16/608,932

(22) PCT Filed: Oct. 31, 2017
(86) PCT No.: PCT/EP2017/077929

§ 371 Date: Oct. 28, 2019

(30) Foreign Application Priority Data
Apr. 28, 2017 (EP) 17382233.9

(51) Int. Cl. B05B 7/04; B05B 7/10; B05B 7/24; B05B 1/34; B05B 1/06

(52) U.S. Cl. CPC B05B 7/0491; B05B 7/0483; B05B 1/06; B05B 7/2497; B05B 1/3447; B05B 7/10

(57) ABSTRACT

Atomizing nozzle which combines two or more substances introduced through at least a first inlet (10) and a second inlet (50), and sprays the resulting atomized droplets through an outlet (110), capable of optimized flow rate and droplet size through a modular design based on interchangeable disk-shaped modules. When stacked in a hollow cylindrical casing conformed by a first housing (20) and a second housing (120), the plurality of modules conform a first mixing chamber (200) and a second mixing chamber (210) connected through a swirl module (60). Furthermore, when said stacking occurs, the first inlet (10) is connected to the first mixing chamber (200), the outlet (110) is connected to the second mixing chamber (210); and the second outlet may be connected to the first mixing chamber (200) or the second mixing chamber (210) depended on the configuration selected by the user.

### FIELD OF THE INVENTION

The present invention has its application within the mechanical and fluidics sectors, especially, in the industrial area engaged in providing spraying nozzles with small droplet size and large flow rates.

### BACKGROUND OF THE INVENTION

Atomizing nozzles capable of spraying one or more liquids into the air in the shape of small droplets are highly sought after in diverse applications such as fire protection (both in indoors systems and outdoors scenarios); decontaminate public areas (e.g. subway stations, railway stations, etc.) and critical infrastructures (e.g. command centres, hospitals, airports, local authorities); industrial manufacturing (e.g. powder metallurgy or extrusion technology); exhaust ad blue or industrial emission cleaning; or snow cannons.

In many of these scenarios, it is of paramount importance to achieve a high flow rate while preserving a small droplet size.

Many different nozzle configurations have already been developed in an effort to fulfil both requirements. In its most basic form, the atomizing nozzle can be implemented with a single cylindrical mixing chamber with an output orifice with a pin in the middle. A liquid inlet and a gas/air inlet are connected to the mixing chamber with a 90° angle between both inlets. Water is feed into the nozzle axially and interacts with the air which enters through the tangential inlet. The mixed fluid flow impacts against the pin, passes through a plurality of slots around said pin and flows out from the orifice.

Nozzle performance can be improved, for example, by including two separate chambers within the nozzle, connected through a plurality of gradient channels. The gas is initially fed to the first chamber (the one further from the output orifice), and is then mixed with the liquid at the second chamber. The axial liquid inlet goes through the first chamber and is directly connected to the second chamber.

Other solutions include air-assist pressure-swirl schemes, where water is supplied from a central inlet and flows through the swirl insert to introduce centrifugal force on water. After spinning in the swirl chamber, water flow out from the small orifice and interact with a strong air flow. Alternatively, water entering from the water inlet may go through a small gap and become a thin liquid sheet. Then it encounters air flow from the outer air inlet, which accelerates the velocity of the water and also increase its instability. High speed air from inner air inlet meets the water at further downstream and blasts it into small droplets.

In spill-return configurations, water is fed from the water inlet and enters the first chamber through three swirl channels. Water in the first chamber can leave the nozzle either from the spill return orifice or from the nozzle orifice. When the full capacity of nozzle is required, valve mounted at spill line will be totally shut so that there will be no liquid being spilled from the nozzle. Once the valve is open, part of the liquid will flow away from the nozzle chamber, resulting in the reduction of flow rate from the orifice. Swirled water flowing out from nozzle orifice will mix with strong air flow in the outer air channel.

Finally, in twin swirl configurations, both the swirl effect of water or air helps with the disintegration of liquid jet and the formation of small drops. Water enters the nozzle accumulates at first chamber and flows to the mixing chamber (second chamber) through three swirl channels on a swirl insert. Air is supplied to the mixing chamber through the gas inlet tangential to it. Both the air and water are swirled in the same direction. Swirl of liquid is reinforced and finally the mixed fluid flows away from the orifice.

In other more complex solutions, such as the one disclosed in U.S. Pat. No. 5,732,885 A, atomization is carried out in three stages. The first stage is carried out by means of a single liquid orifice and an expansion chamber containing an impingement pin. A high velocity stream of liquid is discharged through the liquid orifice and is broken-up upon striking the flat end of the impingement pin. The second stage is produced by an air guide which reduces in area to form jets of air into a high velocity annular air curtain, the curtain passing through the liquid orifice in surrounding relation with the liquid stream and striking the broken-up flow of the first stage to atomize the particles. The mixture is then allowed to expand in the expansion chamber to reduce the tendency of the liquid particles in the atomized mixture from commingling together and reforming into larger particles. The third stage is effected by the expansion chamber and by multiple discharge orifices. The mixture is sprayed from the expansion chamber through the multiple orifices and, upon being discharged into the atmosphere, the particles are atomized further due to the release of pressure formed inside the expansion chamber.

In yet another example, such as the one disclosed in U.S. Pat. No. 6,267,301 B1, flat spray patterns are achieved by including a pair of longitudinally extending air passageways on opposite sides of a central liquid flow stream discharge orifice. The air flow passages each have a discharge orifice defined by a respective transverse deflector flange and a closely spaced inwardly tapered deflector surface which cooperate to deflect and guide pressurized air streams inwardly toward the discharging liquid flow stream for atomizing the liquid and for directing it into a well-defined spray pattern.

However, no solution known in the state of the art can satisfy both conditions simultaneously. For example, twin-fluid nozzles are capable of producing sprays of small droplet sizes and low liquid flow rates while hydraulic nozzle design can produce large flow rates with relatively large droplets. Furthermore, nozzles in the state of the art present a fixed geometry, previously designed for a fixed atomizing problem (i.e. a given input flow of a either a single liquid or a predefined liquid combination). If the output flow and/or droplet size is not optimal, the user does not have the option of reconfiguring the nozzle for its optimization. In the same manner, when the substance or combination of substances being atomized changes, the user cannot adapt nor optimize the nozzle behaviour for the new scenario.

Therefore, there is still the need in the state of the art of a nozzle capable of adapting and optimizing flow rate and droplet change when varying the number or nature of the substances being atomized (e.g. changing fluids, multiple fluids simultaneously, solid particles . . . ).

### SUMMARY OF THE INVENTION

The current invention solves all the aforementioned problems by disclosing a modular atomizing nozzle with interchangeable modules, substantially disk-shaped, with different inner shapes and sizes capable of adapting to varying number and type of spraying substances. The nozzle comprises at least:
A first inlet, through which a first liquid to be atomized is received and introduced in the device.
A second inlet, through which a second substance to be mixed with the first liquid is received. The second inlet may be a liquid inlet for a second liquid or an air inlet, depending on the particular application scenario.
Preferably, the nozzle further comprises a third inlet for a third substance, which depending on particular implementations, may be a solid particle inlet (that is, an inlet for a solid substance to be atomized within the first liquid) or an additional liquid inlet for introducing liquids or any kind of suspended additives.
An outlet, through which atomized droplets comprising a mixture of the first liquid and the second substance (and the third substance if present) are expelled.
Two hollow housing elements, that is, a first housing and a second housing which, when attached to each other conform a hollow cylindrical casing in which the interchangeable disk-shaped modules are placed.
In a first preferred option, both the first housing and the second housing are cylindrical-shaped and are configured to be attached through mating flanges conformed by a first face of the first housing and a second face of the second housing. In this case, the first housing and the second housing are attached by fixing means (such as screws) located in the mating flanges.
In a second preferred option, only the first housing is cylindrical-shaped, being one base of the cylinder fully open, whereas the second housing is disk-shaped and acts as a lid for the first housing. The first housing and second housing are configured to be attached through mating flanges conformed by a first face of the first housing and a second face of the second housing.
A plurality of interchangeable disk-shaped modules with an array of different-shaped and different-sized cavities, which are configured to be stacked inside the hollow casing created by the first housing and the second housing to generate a configurable assemble of mixing chambers. When said stacking occurs, the mixing chamber assemble comprises at least a first mixing chamber, connected by the module cavities to the first inlet, and a second mixing chamber connected to the outlet. The first mixing chamber and the second mixing chamber are connected through the cavities of at least one swirl module, whose geometry and operation may vary depending on the particular embodiment of the invention, as well as on the particular interchangeable module selected within the same embodiment of the invention. The connection of the second inlet (and third inlet if present) to the mixing chambers may also vary depending on the particular embodiment of the invention, as well as on the particular interchangeable modules selected within the same embodiment of the invention.
Preferably, the nozzle further comprises static sealing means such as axial o-ring seals, radial bore-type o-ring seal, crush seals, or a combination thereof.

Depending on the swirling technique and the inlet connection, several preferred mixing schemes can be arranged within the cavities of the stacked modules. Note that said preferred mixing schemes may be arranged within a same embodiment of the invention by choosing a particular sub-set of interchangeable modules. Alternatively, an embodiment of the invention may be adapted to implement a single mixing scheme, being the particular sub-set of selected modules adapted to configure the particular chamber and/or conduct dimensions of said scheme.

In a first preferred mixing scheme, the swirl module comprises a first axial conduct and at least a second slanted conduct (there being typically a plurality of said slanted conducts). That is, there is a relative angle between both conducts greater than or equal to 0° and smaller than or equal to 90° (typically, approximately 45°, although the angle, dimension, number and/or layout of the conducts may vary between embodiments or between interchangeable swirl modules of a same embodiment). Preferably, the first inlet is located on the first housing and is adapted to pass through the first mixing chamber, connect to the first axial conduct, and feed the first liquid directly to the second mixing chamber. In this scheme, the second inlet is fed to the first mixing chamber, and enters the second mixing chamber through the at least one slanted conduct. Also preferably, the nozzle comprises a third inlet located on the second housing, which connects to the second mixing chamber in a direction substantially perpendicular to the first inlet.

In a second preferred mixing scheme, the swirl module comprises a swirl disk with a plurality of slanted lateral conducts which connect the first mixing chamber and the second mixing chamber. The first inlet is preferably located in the first housing, but unlike in the first preferred mixing scheme, the first inlet is more preferably connected directly to the first mixing chamber. The second inlet is preferably located on the second housing and is connected directly to the second mixing chamber. Preferably, the third inlet is connected directly to the nozzle outlet in a direction substantially perpendicular to said outlet.

In a preferred option, independent of the implemented mixing scheme, the first housing, the second housing and the plurality of interchangeable disk-shaped modules are manufactured in two quasi-symmetric halves that are then assembled together along a meridian plane of the nozzle. The two halves are quasi-symmetric, with a symmetry plane defined by the first inlet and second inlet. This enables an easier manufacture, assembly and installation, specially when nozzles of a small size are required.

With the disclosed modular nozzle, the user is therefore able to adapt the mixing scheme and/or the particular dimensions and configurations within a given scheme. This enables said user to optimize droplet size and output flow for a given atomizing scenario (i.e. the particular number, nature and input flow of substances being atomized), as well as to adapt a single nozzle to different scenarios (e.g. when the same nozzle is used to atomize several kinds of liquids or when an additional liquid and/or solid substance is incorporated). Furthermore, the nozzle can work with chemical solutions, solid particles and high pressures. Even in scenarios when severe erosion and abrasion are expected, especially at passageways in the small cross-section areas, the modular design enables to replace the damaged elements without modifying the rest. Additional advantages and features of the invention will become apparent from the detailed description that follows and will be particularly pointed out in the appended claims.

### BRIEF DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows a longitudinal section of a plurality of modular elements which can be assembled into several nozzle configurations, according to a first preferred embodiment of the invention.

FIG. 2 is a longitudinal section of a first nozzle configuration with gradient channels according to said first preferred embodiment of the invention.

FIG. 3 is a longitudinal section of a second nozzle configuration with a twin-swirl module according to said first preferred embodiment of the invention.

FIG. 4 is a longitudinal section of a third nozzle configuration with gradient channels and improved housing according to a second preferred embodiment of the invention.

FIGS. 5a and 5b present two alternative implementations of the swirl element of the invention according to two preferred embodiments thereof.

FIGS. 6a and 6b depict two alternative implementations of the output pin of the invention according to two preferred embodiments thereof.

FIGS. 7a and 7b show two alternative implementations of the sealing means of the invention according to two preferred embodiments thereof.

FIG. 8 schematically depicts a preferred embodiment of the sealing means implemented in the aforementioned first nozzle configuration.

FIG. 9 schematically depicts a preferred embodiment of the sealing means implemented in the aforementioned second nozzle configuration.

FIG. 10 schematically depicts a preferred embodiment of the sealing means implemented in the aforementioned second nozzle configuration.

### DETAILED DESCRIPTION OF THE INVENTION

The matters defined in this detailed description are provided to assist in a comprehensive understanding of the invention. Accordingly, those of ordinary skill in the art will recognize that variation changes and modifications of the embodiments described herein can be made without departing from the scope and spirit of the invention. In particular, note that any particular embodiment or feature of the device of the invention may be applied to the method of the invention and vice versa. Also, description of well-known functions and elements are omitted for clarity and conciseness.

Note that in this text, the term “comprises” and its derivations (such as “comprising”, etc.) should not be understood in an excluding sense, that is, these terms should not be interpreted as excluding the possibility that what is described and defined may include further elements, steps, etc.

In the context of the present invention, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

Note that in the following embodiment descriptions “upper”, “lower”, “vertical” and “horizontal” and any other term referred to relative position assumes that the vertical direction is defined by the main axis of the nozzle, with the first inlet being considered the uppermost position and the outlet being considered the lowermost position. That is, in order to facilitate the understanding of the description and figures, the “first housing” is also referred to as “upper housing”, the “second housing” is also referred to as “lower housing”, the “first mixing chamber” is referred to as “upper mixing chamber”, the “second mixing chamber” is referred to as “lower mixing chamber”, the “first conduct” is referred to as “vertical conduct” and the “second conduct” is referred to as “slanted conduct”. It should be noted, however, that the nozzle may operate in any other orientation or position.

Also note that in the following embodiment descriptions, the “first inlet” is referred to as “liquid inlet”, the “second inlet” is referred to as “air inlet” and the “third inlet” is referred to as “solid particle inlet”. Nevertheless, this nomenclature is only meant to facilitate the understanding of the device operation, without limiting the type of substance introduced through each inlet. For example, in particular embodiments, additional liquids or suspensions could be introduced through the second inlet and/or third inlet. Furthermore, additional inlets for liquid, air, solid particles or any combination thereof could be added in particular embodiments of the invention by including the appropriate inlet inserts, reconfigurable modules and inputs in the upper and/or lower housing.

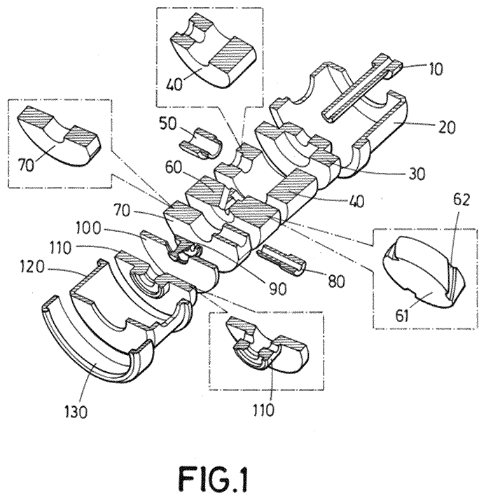

FIG. 1 shows a plurality of interchangeable and stackable disk-shaped modules according to a preferred embodiment of the invention, as well as particular embodiments of the housing means, inlets and outlets. Note that for each module functionality (i.e. mixing, swirling, etc.), different modules with a plurality of cavity sizes and/or layouts may be provided, enabling the user to stack within the housing means the subset of modules which best adapt to each given scenario. Also note that the figure only represents on half of each element in order to display their cavities, being the other half symmetrical to the one displayed.

In the particular embodiment of FIG. 1, the following inlets are comprised:
A vertical liquid inlet (10).
A horizontal air inlet (50).
A horizontal solid particle or additive inlet (80).

Notice that a given embodiment of the invention may comprise a plurality of interchangeable liquid inlets (10), air inlets (50) and/or solid particle inlets (80). Also noticed that, as previously mentioned, the type of substances introduced through each inlet may vary depending on particular embodiments of the invention.

Furthermore, the housing means comprise:
A cylindrical upper housing (20) with an axial orifice in one base for the liquid inlet (10) and a perpendicular radial orifice for the air inlet (50).
A cylindrical lower housing (120) with an axial orifice in one base for the nozzle outlet (110) and a perpendicular radial orifice for the solid particle inlet (80).
Optionally, further housing rings (130) may be provided to adapt the housing of particular embodiments or interchangeable module configurations.

Finally, the nozzle comprises the following stackable disk-shaped modules, with an outer radius that fits the inner radius of the housing means:
An inlet ring (30) which comprises an inner cylindrical cavity that, when stacked, conforms the uppermost part of the first mixing chamber (200). Furthermore, the inlet ring (30) comprises an upper cylindrical protrusion which fits the axil orifice of the cylindrical upper housing (20), having said upper cylindrical protrusion a hole that enables the introduction of the vertical liquid inlet (10).
An upper mixing chamber module (40), comprising a cylindrical axial cavity that creates the main part of the upper mixing chamber (200). Therefore, the radius of the upper mixing chamber (200) can be tuned by selecting from an array of upper mixing chamber modules (40) with different cavity sizes. In the same manner, the height of the upper mixing chamber (200) can be tuned by selecting from an array of upper mixing chamber modules (40) with different heights. The upper mixing chamber module (40) further comprises an axial hole adapted to introduce the horizontal air inlet (50). Note that the same kind of size and shape tunability may be provided to all or a set of the stackable modules of the nozzle, depending to the particular embodiment thereof.
A swirl module (60) which connects the first mixing chamber (200) and the second mixing chamber (210). Two different alternatives for the swirl module (60) are presented, namely a first alternative with a vertical conduct and one or more slanted conducts, and a second alternative with a swirl disk (61) with slanted lateral conducts (62). Interchangeable swirl modules (60) may be provided within each alternative, providing different heights, conduct widths and/or conduct arrangements.
A lower mixing chamber module (70), comprising a cylindrical axial cavity that creates the main part of the lower mixing chamber (210). Therefore, the radius of the lower mixing chamber (210) can be tuned by selecting from an array of lower mixing chamber modules (70) with different cavity sizes. In the same manner, the height of the lower mixing chamber (210) can be tuned by selecting from an array of lower mixing chamber modules (70) with different heights. The lower mixing chamber module (70) may further comprises an axial hole adapted to introduce the horizontal solid particle inlet (80). However, since said solid particle inlet (80) is optional, lower mixing chamber module (70) with no axial holes may be provided.
Optional chamber rings (100) may be provided to adapt chamber sizes or adapt the connection between modules.
A nozzle outlet (110) whose upper part is connected to the lower mixing chamber (210) and whose lower part presents a cylindrical protrusion with an orifice which is the main output of the device. The nozzle outlet (110) may comprise one or more horizontal orifices adapted to be connected to one or more horizontal solid particle inlet (80). However, since said solid particle inlet (80) is optional, nozzle outlet (110) with no horizontal orifices may be provided. In the same manner, regardless of the presence or absence of the solid particle inlet (80), interchangeable nozzle outlets (110) with different thicknesses and/or outlet geometries and configurations may be provided.
Furthermore, the nozzle outlet (110) may comprise an integrated nozzle pin (90), one independent module comprising said nozzle pin (90), or a plurality of interchangeable independent modules comprising different sizes and/or geometries of the nozzle pin (90).

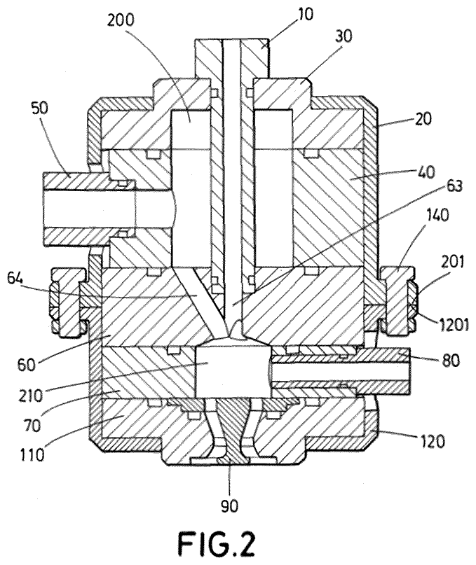

FIG. 2 presents a first nozzle configuration based on gradient channels, which is achieved by stacking a first subset selected from the plurality of interchangeable modules available within an embodiment of the invention. Note that in this case, both the upper housing (20) and the lower housing (120) are cylindrical-shaped and are attached together by a plurality of screws (140) located in mating flanges conformed by a first face (201) of the upper housing (20) and a second face (1201) of the lower housing (120). Nevertheless, any other alternative fixing means known in the state of the art may be used.

In the first nozzle configuration, the liquid inlet (10) comprises a longer cylindrical channel which, when introduced through the inlet ring (30), goes through the upper mixing chamber (200), reaches the vertical conduct (63) of the swirl module (60) and connects with the lower mixing chamber (210). The air inlet (50) is connected to the upper mixing chamber (200), being the upper mixing chamber (200) and lower mixing chamber (210) connected through a plurality of slanted conducts (64). The slanted holes are preferably located around the vertical conduct (63) with a constant angular separation (e.g., three slanted conducts around a single vertical conduct (63) conforming 120° sectors). The slanted conducts (64) are preferable combined with the vertical conduct (63) within the swirl module (60) itself in a lower cavity. Finally, the solid particle inlet (80) is connected horizontally to the lower mixing chamber (210).

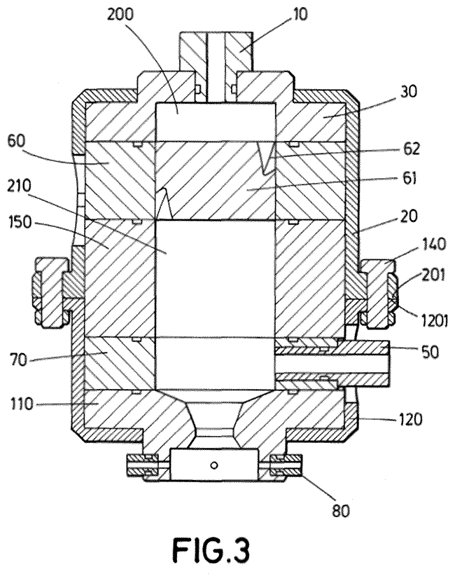

FIG. 3 presents a second nozzle configuration based on a swirl disk, which is achieved by stacking a second subset selected from the plurality of interchangeable modules available within an embodiment of the invention. Note that in this case, both the upper housing (20) and the lower housing (120) are cylindrical-shaped and are attached together by a plurality of screws (140) located in mating flanges conformed by a first face (201) of the upper housing (20) and a second face (1201) of the lower housing (120). Nevertheless, any other alternative fixing means known in the state of the art may be used.

In the second nozzle configuration, the liquid inlet (10) comprises a shorter cylindrical channel which is directly connected to the upper mixing chamber (200). Note that the upper mixing chamber (200) is shorter than in the previous case, being conformed only by the inlet ring (30) without the need of an upper mixing chamber module (40). On the other hand, the lower mixing chamber (210) is higher than in the previous case, requiring one or more auxiliary modules (150) which merely comprises an axial cylindrical cavity with the same width as the lower mixing chamber (210). The upper mixing chamber (200) and lower mixing chamber (210) have the same width and are connected through a swirl disk (61) with a plurality of slanted lateral conducts (62) which induce liquid and air swirling improving mixing. Note that air inlet (50) is connected horizontally to the lower mixing chamber (210) whereas two separate solid particle inlets (80) are connected directly to the nozzle outlet (110). In this second nozzle configuration, liquid and gas spin in different direction before they bump into each other, making the interactions between the gas and the liquid more intensive.

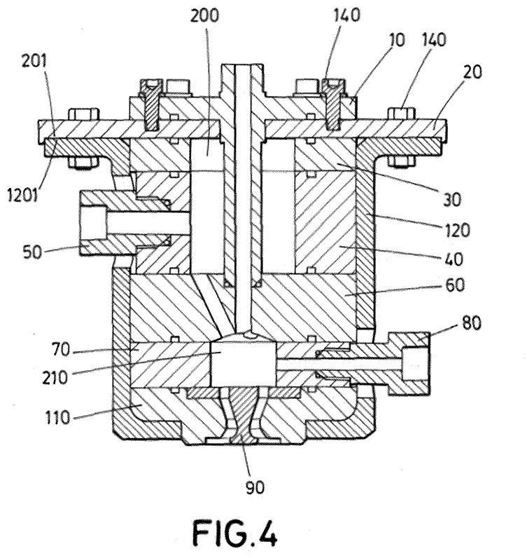

FIG. 4 presents a third nozzle configuration, also based on gradient channels, which is achieved by stacking a second subset selected from the plurality of interchangeable modules available within an embodiment of the invention. Note that in this case, the lower housing (120) is cylindrical-shaped, but the upper housing (20) is disk-shaped, acting as a lid of the lower housing (120). The upper housing (20) and the lower housing (120) are attached by a plurality of screws (140) located in mating flanges conformed by a first face (201) of the upper housing (20) and a second face (1201) of the lower housing (120). Furthermore, the liquid inlet (10) presents a lateral disk-shaped protrusion which enables said liquid inlet (10) to also be attached to the upper housing (20) through a plurality of screws (140). Nevertheless, any other alternative fixing means known in the state of the art may be used.

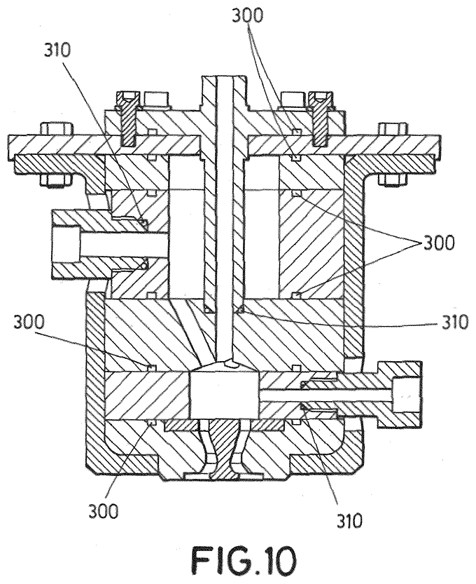

The operation of the third nozzle configuration is similar to the first nozzle configuration, with the modules presenting slightly adapted geometries to improve sealing and substance introduction. For example, note that upper protrusion of the inlet ring (30) is no longer present, as the liquid inlet (10) is directly connected to the upper housing (20). Also, the lateral orifice of the lower mixing chamber module (70) presents two segments with different widths, so the solid particle inlet (80) does not connect directly to the lower mixing chamber (210) but gets attached to a middle position of the lateral orifice instead. Furthermore, the tips of the liquid inlet (10), the air inlet (50) and solid particle inlet (80) present slanted corners for improved sealing, as will be further detailed in FIGS. 7b and 10.

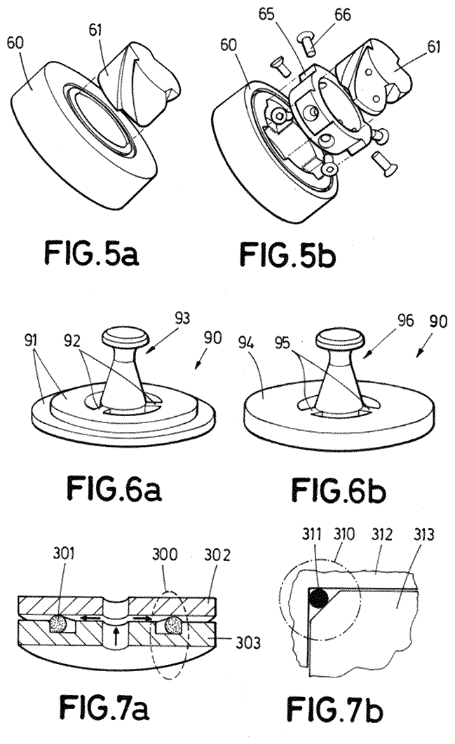

FIG. 5a presents in further detail the swirl module (60) of the second nozzle configuration, with a cylindrical annular housing to which the swirl disk (61) is attached. The swirl disk is also cylindrical, with three equidistant slanted lateral conducts (62) on its sidewall. Alternatively, FIG. 5b presents a more robust embodiment of the swirl module (60), incorporating an auxiliary housing (65) which is screwed to the swirl disk (61) through screws (66) and the ensemble is introduced in the outermost element of the swirl module (60). The auxiliary housing (65) presents equidistant radial protrusions which are inserted in radial cavities with a complementary shape located in the outermost element for improved attachment. This configuration also enables to modify the position of the slanted lateral conducts (62) within the base of the upper mixing chamber (200).

FIG. 6a presents in further detail a first implementation of the nozzle pin (90). This first nozzle pin (90) implementation comprises a base with two disks (91), which are crossed through by three openings located around a first pin tip (93). The pin is held in position by three first auxiliary radial elements (92) which, in this case, present square edges. Output flow may nevertheless be further optimized with the second implementation of the nozzle pin (90) shown in FIG. 6b. This second nozzle pin (90) implementation comprises only one disk (94), three second auxiliary radial elements (95) with rounded edges and a second nozzle pin tip (96) with a smoother profile.

FIG. 7a illustrates a first alternative for sealing the spaces between the interchangeable modules, bases on static bore-type axial o-ring seals (300). A first sealing ring (301) is introduced into a small ring cavity of a first planar surface (303), which is then stacked under a second planar surface (302). The pressure between the first planar surface (303) and the second planar surface (302) squeezes the first sealing ring (301), preventing any lateral liquid flow. In the same manner, FIG. 7b illustrates a second alternative for sealing the spaces between the interchangeable modules, bases on static crush seals (310). Instead of using two planar surfaces, a second sealing ring (311) is included in a corner between a concave surface (312) and a convex surface (313).

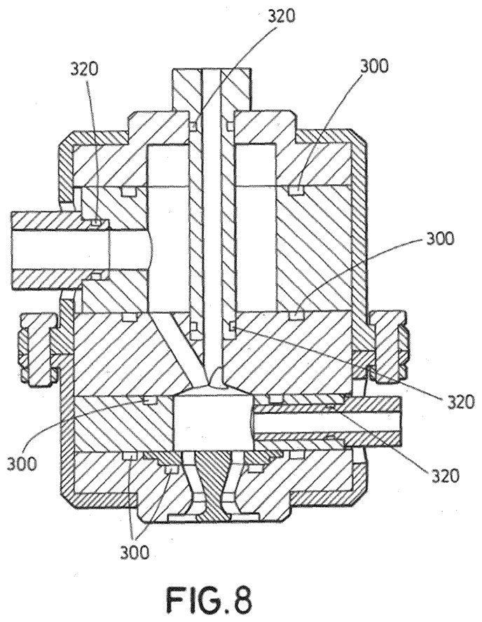

FIG. 8 schematically depicts a possible embodiment of the sealing means for the first nozzle configuration. Axial o-ring seals (300) are incorporated between the upper mixing chamber module (40) and the inlet ring (30), between the upper mixing chamber module (40) and the swirl module (60), between the swirl module (60) and the lower mixing chamber module (70), between the lower mixing chamber module (70) and the nozzle outlet (110) and between the nozzle outlet (110) and the nozzle pin (90). Radial o-ring seals (320) are incorporated between the liquid inlet (10) and the inlet ring (30), between the liquid inlet (10) and the swirl module (60), between the air inlet (50) and the upper mixing chamber module (40), and between the solid particle inlet (80) and the lower mixing cavity module (70). Radial o-ring seals (320) operate in the same manner as axial o-ring seals (300), with the only difference that the cavity for the sealing rings is engraved in a cylindrical surface.

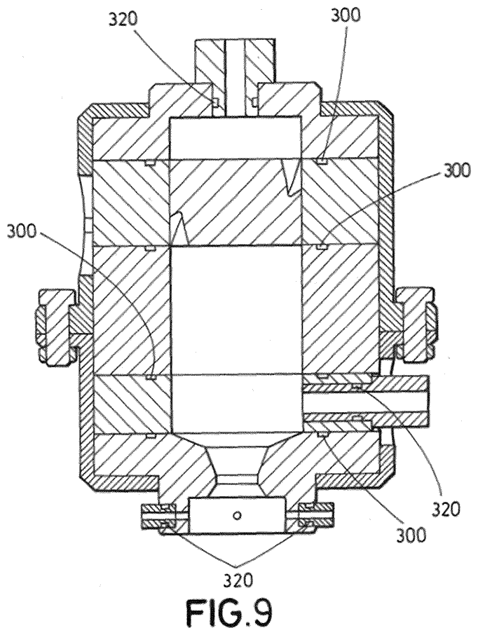

FIG. 9 schematically depicts a possible embodiment of the sealing means for the second nozzle configuration. Axial o-ring seals (300) are incorporated between the inlet ring (30) and the swirl module (60), between the swirl module (60) and the auxiliary module (150), between the auxiliary module (150) and the lower mixing chamber module (70), and between the lower mixing chamber module (70) and the nozzle outlet (110). Radial o-ring seals (320) are incorporated between the liquid inlet (10) and the inlet ring (30), between the air inlet (50) and the lower mixing chamber module (70), and between the solid particle inlet (80) and the nozzle outlet (110).

FIG. 10 schematically depicts a possible embodiment of the sealing means for the third nozzle configuration. Axial o-ring seals (300) are incorporated between the liquid inlet (10) and the upper housing (20), between the upper housing (20) and the inlet ring (30), between the inlet ring (30) and the upper mixing chamber module (40), between the upper mixing chamber module (40) and the swirl module (60), between the swirl module (60) and the lower mixing chamber module (70), and between the lower mixing chamber module (70) and the nozzle outlet (110). Crush seals (310) are incorporated between the liquid inlet (10) and the swirl module (60), between the air inlet (50) and the upper mixing chamber module (40), and between the solid particle inlet (80) and the lower mixing chamber module (70).

Finally, note that the materials of the different components may be adapted depending on the substances being atomized and other factors such as temperature range and corrosion. Some viable materials include nozzles include brass, bronze, cast iron, stainless steels, nickel-based alloys to a wide range of plastics. More particularly, in scenarios where chemical resistance and abrasion resistance are required, due to the presence of decontamination agents and solid particles (e.g. metallic oxides—FeO, Al2O3 and ceramic materials—Si3N4, SiC), the following materials are recommended: hardened stainless-steel, hard alloys (Cobalt alloy 6), Tungsten carbide and ceramics (Silicon carbide, Boron carbide). For example, in a first preferred embodiment, ceramic materials are used for nozzle outlet (110), nozzle pin (90) and solid particle inlet (80), whereas stainless steel is used for the rest of the components. In another example, Aluminum alloys may be used.

What is claimed is:

1.-14. (canceled)

15. An atomizing nozzle for spraying liquid droplets comprising:
at least a first inlet configured to receive a first liquid;
a second inlet configured to receive a second substance to be mixed with the first liquid, and an outlet configured to allow atomized droplets comprising a mixture of the first liquid and the second substance be expelled, a first housing and a second housing configured to be attached to each other to conform a hollow cylindrical casing; and
a plurality of interchangeable disk-shaped modules:
configured to be stacked inside the hollow cylindrical casing;
comprising a plurality of different-shaped cavities configured to:
conform a first mixing chamber;
conform a second mixing chamber;
conform a swirl module connecting the first mixing chamber to the second mixing chamber;
connect the first inlet to the first mixing chamber;
connect the second mixing chamber to the outlet;
wherein the swirl module comprises:
at least a first conduct and a second conduct adapted to connect to the second mixing chamber, wherein the first conduct and the second conduct form an angle greater than or equal to 0° and smaller than or equal to 90°; or
a swirl disk with a plurality of slanted lateral conducts.

16. The atomizing nozzle according to claim 15 wherein the first inlet is located on the first housing and is configured to pass through the first mixing chamber to connect to the first conduct.

17. The atomizing nozzle according to claim 15 characterized in that the second inlet (50) and the second conduct (64) are connected to the first mixing chamber (200).

18. The atomizing nozzle according to claim 15 wherein the nozzle further comprises a third inlet located on the second housing and connected to the second mixing chamber in a direction substantially perpendicular to the first inlet.

19. The atomizing nozzle according to claim 15 wherein the first inlet is located on the first housing.

20. The atomizing nozzle according to claim 15 wherein the second inlet is connected to the second mixing chamber and is located on the second housing.

21. The atomizing nozzle according to claim 19 wherein the nozzle further comprises a third inlet connected to the outlet in a direction substantially perpendicular to the outlet.

22. The atomizing nozzle according to claim 15, wherein the first housing and the second housing are both cylindrical housings, wherein the first housing comprises a first face configured to be connected to the second housing and the second housing comprises a second face configured to be connected to the first housing, the first face and the second face conforming mating flanges to attach the first housing and the second housing to each other.

23. The atomizing nozzle according to claim 15, wherein the second housing is a cylindrical housing and the first housing is a disk-shaped lid, wherein the first housing comprises a first face configured to be connected to the second housing and the second housing comprises a second face configured to be connected to the first housing , the first face and the second face conforming mating flanges to attach the first housing and the second housing to each other.

24. The atomizing nozzle according to claim 23 wherein the first housing is further adapted to be screwed together with the first inlet.

25. The atomizing nozzle according to claim 15 characterized in that the nozzle further comprises at least one static axial o-ring seal (300) between two disk-shaped modules.

26. The atomizing nozzle according to claim 15, wherein the nozzle further comprises at least one static crush seal between a disk-shaped module and an inlet.

27. The atomizing nozzle according to claim 15, wherein each of the first housing, the second housing and the plurality of interchangeable disk-shaped modules comprises two quasi-symmetric assemblable halves along a meridian plane of the nozzle.
